(19) United States
(12) Patent Application Publication
(10) Pub. No.: US 2025/0222803 A1
(43) Pub. Date: Jul. 10, 2025

(54) On-Board Chargers And Components Thereof For Electric Vehicles

(71) Applicant: xEVtech Co. Ltd., Baria city (VN)

(72) Inventor: Ngoc Hai Tran, Ba Ria city (VN)

(21) Appl. No.: 18/409,066

(22) Filed: Jan. 10, 2024

(51) Int. Cl. B60L 53/22; B60L 50/40; H02J 7/02; H02J 7/34

(52) U.S. Cl. CPC B60L 53/22; H02J 7/02; H02J 7/345; B60L 50/40; B60L 2210/12; H02J 2207/20

(57) ABSTRACT

An on board charger with a multi-function circuit is provided for an electric vehicle and similar applications that uses non-electrolytic capacitors and can switch between different electrical input sources such as single-phase AC, 3-phase AC and DC, and which uses different sized airgaps between magnetic components and hybrid windings for its magnetic components.

### FIELD OF THE INVENTION

The invention relates to on-board chargers and circuits for such for electric vehicles and other applications.

### BACKGROUND OF THE INVENTION

The use of on-board chargers for electric vehicles can be problematic because of the different sources of input electricity that may be supplied in a particular area or circumstance, potential losses of efficiency, use of disadvantageous electrolytic capacitors, parasitic currents, flux coupling, and their large size. Improved on-board chargers for electric vehicles that are highly efficient and that can seamlessly switch between different sources are needed that solve or otherwise reduce the effects of some or all of these problems.

### SUMMARY OF THE INVENTION

Embodiments of this invention solve or otherwise reduce the effects of some or all of the problems of on-board chargers for electric vehicles and other similar applications.

In certain preferred embodiments of this invention, an on-board charger for an electric vehicle is provided. The on-board charger comprises a number of components including a multi-function circuit, multiple magnetic components, and a DC-link.

The multi-function circuits comprise connections for inputs of voltage, using an active front end circuit of the on-board charger that facilitates the use of variable sources of electricity. These sources comprise single-phase AC, 3-phase AC, and DC sources. The inputs of voltage to the multi-function circuit are selected by a single pole single throw relay in the multi-function circuit that switches between the variable sources and which can isolate one or more of the multiple magnetic components.

The multiple magnetic components of the on-board charger are each connected to the multi-function circuit and are integrated into one device. The magnetic components comprise inductors and transformers, each with integrated cores. The inductors and transformers comprise a DC transformer for the on-board charger and a low voltage DC-DC converter, wherein the windings of the DC transformer for the on-board charger are comprised of PCB windings, the windings of the inductors are comprised of solid wire windings, and the windings of the low voltage DC-DC converter are comprised of litz wire windings and PCB windings. The integrated cores of the magnetic components use different sized airgaps, including zero airgap, to prevent flux coupling.

The low voltage DC-DC converter, when isolated by the relay of the multi-function circuit, operates as a DC transformer with respect to the inputs of voltage to the multi-function circuit. The multi-function circuit also includes a connection to the DC-link of the on-board charger that comprises a non-electrolytic film capacitor, thus avoiding the disadvantages of the size and other properties of electrolytic capacitors. In certain embodiments, the low voltage DC-DC converter comprises a buck convertor that enables the low voltage DC-DC converter to operate as a DC transformer in the multi-function circuit.

In addition, other preferred embodiments of this invention comprise multi-function circuits for on-board chargers with a DC-link, the on-board chargers being for use with an electric vehicle or a similar application.

Embodiment of these multi-function circuits comprise a number of components and connections. These include a connection to a non-electrolytic film capacitor at the DC-link of the charger. These also include a relay that when opened separates the multi-function circuit into a power decoupling converter and when closed forms an interleaved buck converter.

These also include connections to a plurality of magnetic components, each with integrated cores, the magnetic components comprising a DC transformer for the on-board charger, a plurality of inductors, and a low voltage DC-DC converter. The integrated cores of the magnetic components are separated by different sized airgaps, including zero airgap, to prevent flux between the magnetic components. These magnetic components are integrated into a discrete device. The DC transformer for the on-board charger comprises PCB windings, each of the plurality of inductors comprises solid wire windings, and the low voltage DC-DC converter comprises litz wire windings and PCB windings.

These also include connections for input from different voltage sources, the different input voltage sources comprising a single-phase AC source, a 3-phase AC source, or a DC source.

In operation, when the source is a single-phase AC source in these embodiments, the relay is opened and it separates the multi-function circuit into the power decoupling converter which processes the second-harmonic of the single-phase AC source input and stores it to power the capacitor. When the source is a 3-phase AC source or a DC source, the relay is closed and the low voltage DC-DC converter operates as a DC transformer. In certain embodiments, the low voltage DC-DC converter comprises a buck convertor.

Applications for the embodiments of this invention include for electric vehicles and other similar applications. The person of ordinary skill in the art understands how these applications can be used with this invention.

Advantages of the embodiments of this invention are described and apparent throughout this specification. For example, certain embodiments permit the use of different sources of input electricity that may be supplied in a particular area or circumstance, reduced losses of efficiency, avoid the use of disadvantageous electrolytic capacitors, reduce parasitic currents, reduce flux coupling, and have smaller sizes. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic showing the general structure of embodiments of the multi-function circuits for non-electrolytic capacitor on-board chargers with magnetic integration of this invention. FIG. 1 illustrates the use of a buck converter.

FIG. 2 is a perspective view of a schematic showing details of integrated magnetic features (individually and then combined together) of embodiments of the multi-function circuits for non-electrolytic capacitor on-board chargers with magnetic integration of this invention.

FIG. 3 is a perspective view of a schematic showing details of an integrated core feature (“Integrated core 1”) of embodiments of the multi-function circuits for non-electrolytic capacitor on-board chargers with magnetic integration of this invention.

FIG. 4 is a perspective view of a schematic showing details of an integrated core concept of embodiments of the multi-function circuits for non-electrolytic capacitor on-board chargers with magnetic integration of this invention.

FIG. 5 is a schematic showing the general structure of embodiments of the multi-function circuits for non-electrolytic capacitor on-board chargers with magnetic integration of this invention. FIG. 5 illustrates embodiments of this invention where a buck converter is not used (as compared to FIG. 1).

FIG. 6 is a schematic showing the general structure of embodiments of on-board chargers with multi-function circuits of this invention.

FIG. 7 is a schematic showing the structure of single-phase AC source equivalent circuits of embodiments of on-board chargers with multi-function circuits of this invention.

FIG. 8 is a schematic showing the structure of three-phase AC source equivalent circuits of embodiments of on-board chargers with multi-function circuits of this invention.

FIG. 9 is a schematic showing the structure of DC source equivalent circuits of embodiments of on-board chargers with multi-function circuits of this invention.

### DETAILED DESCRIPTION OF THE INVENTION

### Glossary

RL: Relay
OBC: On-board charger
LDC: Low-voltage DC-DC converter
DCX: DC transformer
DCX-OBC: DCX of the OBC
DCX-LDC: DCX of the LDC
HV: High voltage
LV: Low voltage
Integrated core: A piece of core that is used for multiple magnetic components (transformers and inductors)
MC: Multi-function circuit
AFE: Active Front End

Embodiments of this invention provide MCs for non-electrolytic capacitor OBCs with magnetic integration of magnetic devices.

MC embodiments of this invention enable isolated DC-DC converters to operate as a DCX with different input voltage sources (e.g., DC source, single-phase AC source, 3-phase AC source). MCs of embodiments of this invention also enable the elimination or reduction of the need for an electrolytic capacitor at the dc-link of on-board chargers.

Integrated cores are used for multiple magnetic components, including inductors and transformers of MCs, DCX-OBC, and LDC. Embodiments of integrated magnetic systems of this invention use hybrid windings comprising PCB winding and both solid wire and litz wire.

Specifically, concerning these hybrid windings, first, the transformer of the OBC fully utilizes PCB winding for low-profile, high power density, as well as for control over parasitic currents. This structure has a low-profile and large footprint that enables integration of other magnetic components on top of the PCB-winding based transformer of the DCX-OBC.

Second, solid wire is used for inductors due to lower switching frequency and the high number of turns.

Third, hybrid windings are used for the transformer of the DCX-LDC: (a) litz wire is used for the primary side to reduce ac loss due to the high number of turns; (b) the secondary side utilizes only a single turn, and, therefore, PCB winding is used to reduce terminal loss and volume due to the high current conducted.

An airgap is used to prevent flux coupling between the integrated cores of the magnetic components.

Multi-input sources (e.g., single-phase AC, 3-phase AC, DC) are compatible with the on-board charger.

A buck converter is used as an option in certain embodiment of the LDC, which provides it with two advantages: first, it enables the isolated dc-dc converter of the LDC to operate as a DCX for higher efficiency, and second, it extends the voltage range regulation compared to the conventional LLC circuit.

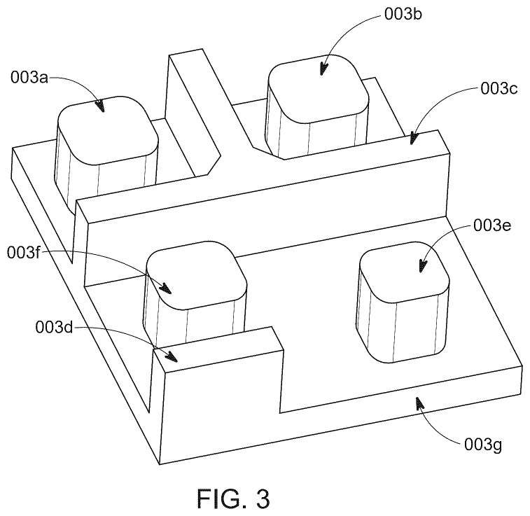

In embodiments of this invention, the common leg 1 (003c in FIG. 3) and the common leg 2 (003d in FIG. 3) of an integrated core (Integrated core 1) is connected to another integrated core (Integrated core 2) with no airgap, providing a mechanical stability for the integrated core system. A different amount of airgap is set between other integrated core components (e.g., the Integrated core 2 and the Leg 1, Leg 2, Leg 3, Leg 4 of the Integrated core 1) to prevent flux coupling between windings of each of the magnetic components.

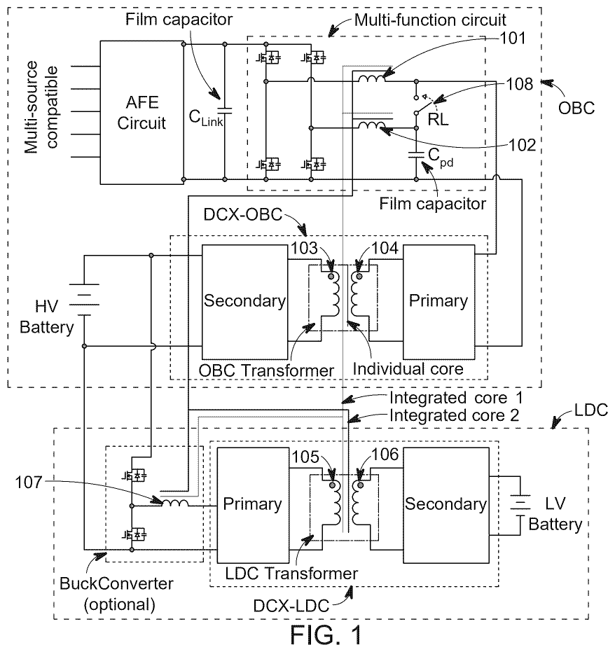

FIG. 1 is a schematic that illustrates the general structure of embodiments of multi-function circuits for the non-electrolytic capacitor on-board chargers with magnetic integration of this invention. FIG. 1 illustrates an OBC connected to an LDC.

The OBC of FIG. 1 shows multi-source compatibility through an AFE. Film capacitor, MC, HV battery, and DCX-OBC, with primary and secondary windings, OBC transformer and individual core components are also shown with relevant connections. Component 101 is the winding of the first inductor in the MC which uses solid wire. 102 is the winding of the second inductor in the MC which uses solid wire. 103 is the secondary winding of the OBC transformer which uses a PCB-based winding. 104 is the primary winding of the OBC transformer which uses a PCB-based winding.

The LDC of FIG. 1 shows DCX-LDC, primary and secondary windings, LDC transformer, LV battery, and optional buck converter components with relevant connections. 105 is the primary winding of the LDC transformer which uses litz wire. 106 is the secondary winding of the LDC transformer which uses PCB-based winding. 107 is the winding of the inductor in LDC buck converter which uses solid winding. 108 is a single pole single throw relay used in the MC to switch between different input sources.

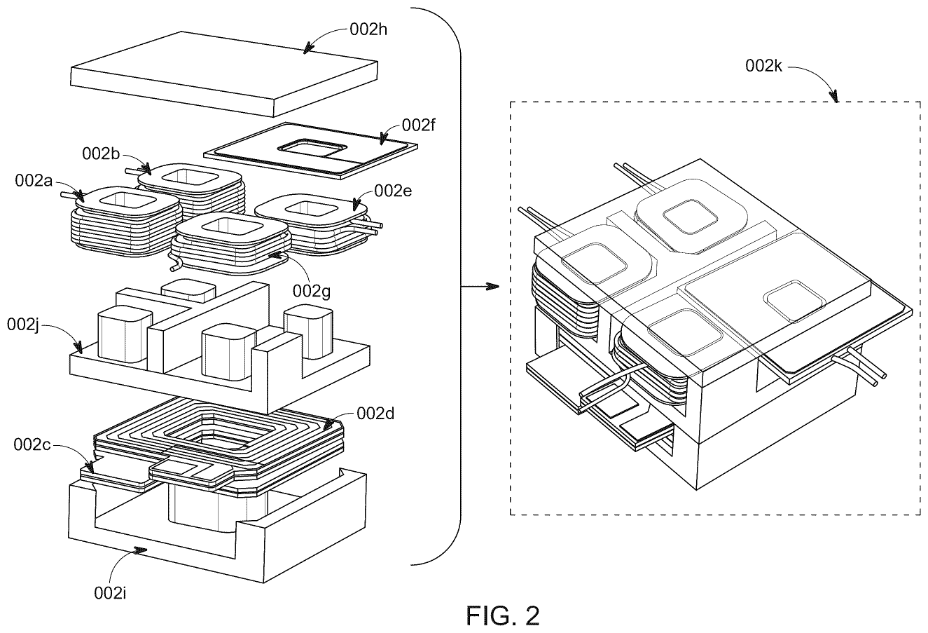

FIG. 2 illustrates integrated magnetic features of embodiments of multi-function circuits for the non-electrolytic capacitor on-board chargers with magnetic integration of this invention. FIG. 2 specifically illustrates the concept of embodiments of an integrated magnetic device for the on-board charger of this invention.

In FIG. 2, 002a is 101 (the winding of the first inductor in the MC which uses solid wire) in FIG. 1. 002b is 102 (the winding of the second inductor in the MC which uses solid wire) in FIG. 1. 002c is 103 (the secondary winding of the OBC transformer which uses PCB-based windings) in FIG. 1. 002d is 104 (the primary winding of the OBC transformer which uses PCB-based windings) in FIG. 1. 002e is 105 (the primary winding of the LDC transformer which uses litz wire) in FIG. 1. 002f is 106 (the secondary winding of the LDC transformer which uses PCB-based windings) in FIG. 1. 002g is 107 (the winding of the inductor in LDC the buck converter which uses solid windings) in FIG. 1. 002h is “Integrated core 2 specifically in FIG. 1. 002i: is “Individual core” in FIG. 1. 002j is “Integrated core 1” in FIG. 1.

In FIG. 2, 002k is the complete model of the integrated magnetic device for certain embodiments of the on-board chargers of this invention.

FIG. 3 illustrates an integrated core feature (“Integrated core 1” of FIG. 1) of embodiments of the multi-function circuits for non-electrolytic capacitor on-board chargers with magnetic integration of this invention.

In FIG. 3, 003a is Leg 1 which is used to wound the winding of the first inductor of the MC. 003b is Leg 2 which is used to wound the winding of the second inductor of the MC. 003c is the common leg 1, to conduct the flux generated by the winding in the integrated core. 003d is the common leg 2, to conduct the flux generated by the winding in the integrated core. 003e is Leg 3 which is used to wound the primary and secondary windings of the LDC transformer. 003f is Leg 4 which is used to wound the winding of the inductor of the LDC buck converter. 003g is a bottom side of the Integrated core 1. This magnetic part conducts the flux generated from both the OBC transformer and the magnetic components placed in the integrated cores.

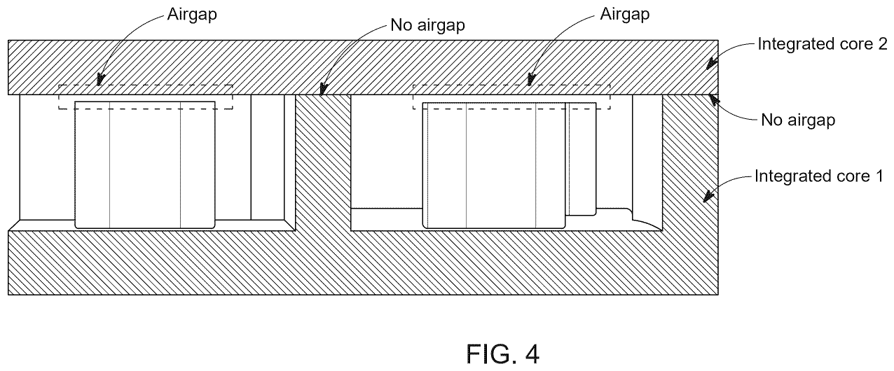

FIG. 4 is a perspective view of a schematic showing details of an integrated core concept of embodiments of the multi-function circuits for non-electrolytic capacitor on-board chargers with magnetic integration of this invention.

In FIG. 4, the common leg 1 (003c in FIG. 3) and the common leg 2 (003d in FIG. 3) of the Integrated core 1 is connected to Integrated core 2 with no airgap, providing mechanical stability for the integrated core system. A different amount of airgap is set between the Integrated core 2 and the Leg 1, Leg 2, Leg 3, and Leg 4 of the Integrated core 1 to prevent the flux coupling between windings of each of the magnetic components.

The LDC buck converter is an optional component of embodiments of this invention. A buck converter (or step-down converter) is a DC-to-DC converter which decreases voltage, while increasing current, from its input (supply) to its output (load). It is a class of switched-mode power supply.

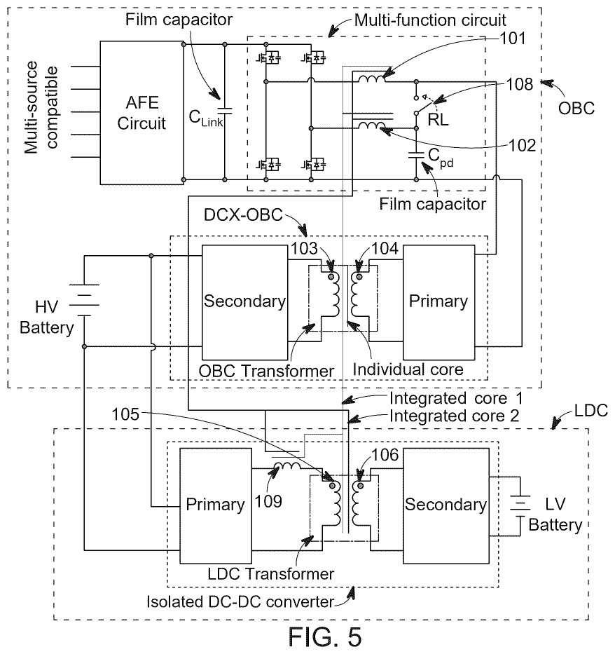

FIG. 5 is a schematic showing the general structure of embodiments of the multi-function circuits for non-electrolytic capacitor on-board chargers with magnetic integration of this invention. FIG. 5 illustrates embodiments of this invention where a buck converter is not used.

In FIG. 5, when a buck converter is not used at the LDC, the isolated DC-DC converter needs to have a series inductor in front of the transformer to ensure the control capability of the converter, and therefore, the integrated magnetic structure can maintain the same. The difference from the embodiments shown in FIG. 1 is only from the converter side where the inductor of the LDC buck converter in FIG. 1 (107 in FIG. 1) is used as a series inductor of the LDC converter in FIG. 5 (109 in FIG. 5).

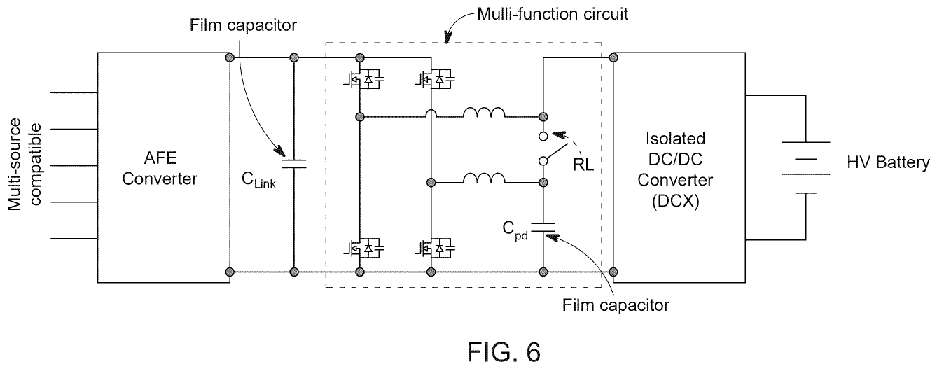

The operation of an OBC with multi-function circuits of embodiments of this invention is illustrated in FIGS. 6-9.

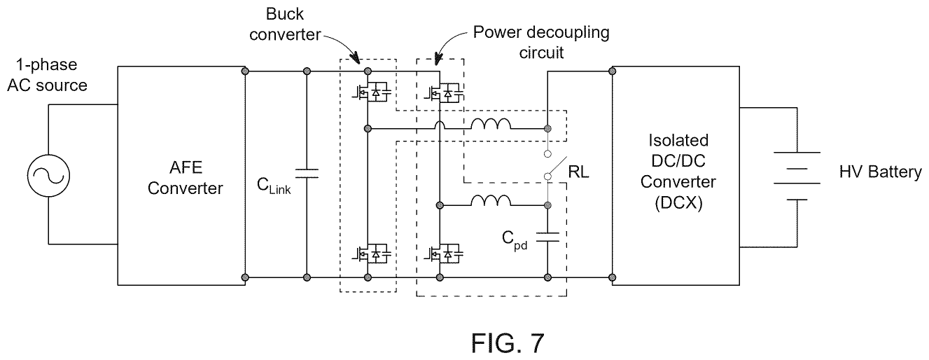

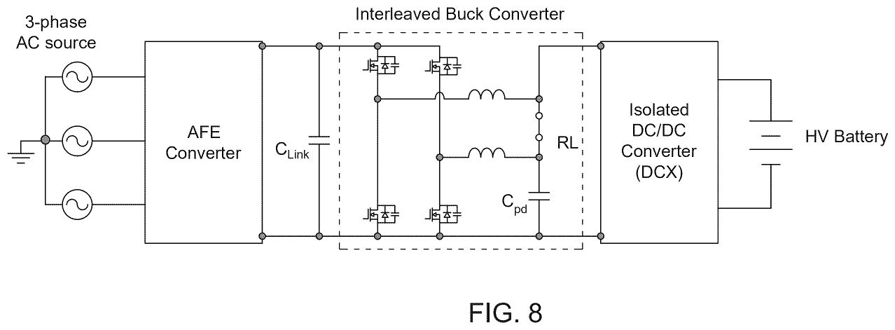

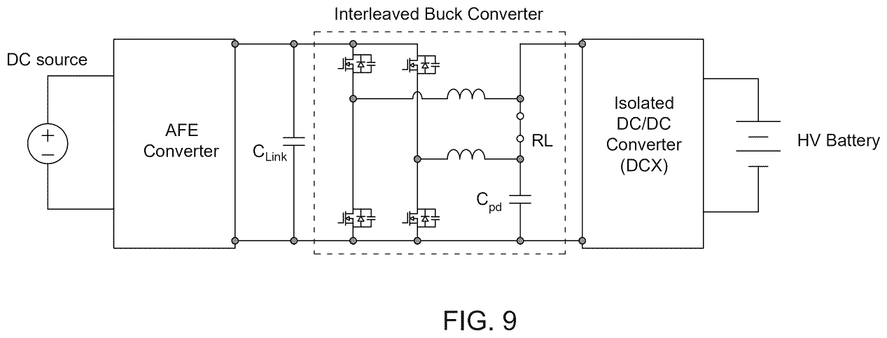

FIG. 6 is a schematic showing the general structure of embodiments of on-board chargers with multi-function circuits of this invention. FIG. 7 is a schematic showing the structure of single-phase AC source equivalent circuits of embodiments of on-board chargers with multi-function circuits of this invention. FIG. 8 is a schematic showing the structure of three-phase AC source equivalent circuits of embodiments of on-board chargers with multi-function circuits of this invention. FIG. 9 is a schematic showing the structure of DC source equivalent circuits of embodiments of on-board chargers with multi-function circuits of this invention.

In operation, as shown by FIGS. 6-9, the multi-function circuit (MC) operates differently depending on the input voltage sources. When the input is from a single-phase AC source (FIG. 7), RL is opened separating the MC into two converters: a 1) Power Decoupling converter which processes the second-harmonic of the single-phase grid and stores it to power the decoupling capacitor Cpd; and 2) the buck converter which regulates the input voltage of the isolated dc-dc converter, enabling the isolated dc-dc converter to operate as a DCX.

When the input is a three-phase AC source (FIG. 8) or a DC voltage source (FIG. 9), the RL is closed causing MC to become an interleaved buck converter, enabling the isolated dc-dc converter to operate as a DCX. Due to this interleaved approach, the delivered power capability in the three-phase AC source and DC voltage source is higher than that of the single-phase AC source.

The reference, “Unbalanced Half-bridge Split Capacitor Power Decoupling With Multi-Order Frequency Control For 800V On-Board Battery Charger”, Tuyen D. Nguyen, et al., IEEE Transactions On Transportation Electrification, Jul. 31, 2023, is hereby incorporated by reference in its entirety, to provide additional background, teaching and discussion.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A multi-function circuit for an on-board charger with a dc-link, the charger for use with an electric vehicle, the multi-function circuit comprising:
a. connection to a non-electrolytic film capacitor at the de-link of the charger;
b. a relay that when opened separates the multi-function circuit into a power decoupling converter and when closed forms an interleaved buck converter;
c. connection to a plurality of magnetic components, each with integrated cores, the magnetic components comprising a DC transformer for the on-board charger, a plurality of inductors, and a low voltage DC-DC converter, the plurality of magnetic components separated by different sized airgaps, including zero airgap, to prevent flux between the magnetic components, the plurality of magnetic components being integrated into a discrete device;
d. the DC transformer for the on-board charger comprising PCB windings;
e. each of the plurality of inductors comprising solid wire windings;
f. the low voltage DC-DC converter comprising litz wire windings and PCB windings;
g. connections for input from different voltage sources, the different input voltage sources comprising a single-phase AC source, a 3-phase AC source, or a DC source;
h, wherein, in operation, when the source is a single-phase AC source, the relay is opened and it separates the multi-function circuit into the power decoupling converter which processes the second-harmonic of the single-phase AC source input and stores it to power the capacitor; and
i, wherein, in operation, when the source is a 3-phase AC source or a DC source, the relay is closed and the low voltage DC-DC converter operates as a DC transformer.

2. The circuit of claim 1 wherein the low voltage DC-DC converter comprises a buck convertor.

3. An on-board charger for an electric vehicle, the charger comprising a multi-function circuit, multiple magnetic components, and a DC-link, the multi-function circuit comprising;
a. connections for inputs of voltage to the multi-function circuit, from an active front end circuit of the on-board charger that facilitates the use of variable sources comprising single-phase AC, 3-phase AC, and DC sources, the inputs of voltage selected by a single pole single throw relay in the multi-function circuit that switches between the variable sources and which can isolate one or more of the multiple magnetic components;
b. wherein the multiple magnetic components are each connected to the multi-function circuit and the multiple magnetic components are integrated into one device, the magnetic components comprising inductors and transformers, each with integrated cores, the inductors and transformers comprising a DC transformer for the on-board charger and a low voltage DC-DC converter, wherein the windings of the DC transformer for the on-board charger are comprised of PCB windings, the windings of the inductors are comprised of solid wire windings, and the windings of the low voltage DC-DC converter are comprised of litz wire windings and PCB windings;
c. wherein different sized airgaps, including zero airgap, are used between the integrated cores of the magnetic components to prevent flux coupling;
d. wherein the low voltage DC-DC converter, when isolated by the relay of the multi-function circuit, operates as a DC transformer with respect to the inputs of voltage to the multi-function circuit; and
e. connection to the DC-link of the on-board charger that comprises a non-electrolytic film capacitor.

4. The on-board charger of claim 3 wherein the low voltage DC-DC converter comprises a buck convertor that enables the low voltage DC-DC converter to operate as a DC transformer in the multi-function circuit.
